(19) United States
(12) Patent Application Publication
(10) Pub. No.: US 2011/0101698 A1
(43) Pub. Date: May 5, 2011

(54) Wind powered vehicle

(76) Inventor: Raymond Saluccio, Colonia, NJ (US)

(21) Appl. No.: 12/590,191

(22) Filed: Nov. 4, 2009

(51) Int. Cl. F03D 9/00; H02J 7/35; F03B 17/04

(52) U.S. Cl. 290/55; 320/101; 74/DIG. 9

(57) ABSTRACT

The present invention provides a wind-powered vehicle having turbine blades mounted on the vehicle at a location to receive wind to rotate the blades when the vehicle is being driven. A generator is connected to the turbine blades so that when the turbine blades rotate the generator produces electricity. One or more ducts are disposed behind the turbine blades to guide the wind to one or more exit ports on the ducts. One or more storage batteries are located on the vehicle for receiving and storing electricity produced by the generator. One or more electric wires are connected between the generator and the storage batteries for transferring the electricity produced by the generator to the storage batteries. The electric batteries are connected to the vehicle to drive and propel the vehicle.

### FIELD OF THE INVENTION

This invention relates to a wind powered vehicle having wind driven turbine blades mounted thereon which are connected to a generator for producing electricity which is supplied to storage batteries on the vehicle, which propel and drive the vehicle. In addition, the vehicle has a solar membrane on its roof.

### BACKGROUND OF THE INVENTION

Wind is a known source of energy, but it has not been used to power a vehicle in the manner described by this invention.

### OBJECTS OF THE PRESENT INVENTION

It is an object of the present invention to provide a vehicle with wind driven turbine blades connected to a generator for producing electricity which is supplied to electric storage batteries located on the vehicle for driving and propelling the vehicle.

It is another object of the present invention to have the vehicle connected to a trailer, wherein the trailer has the wind drive turbine blades connected to a generator for producing electricity which is supplied to electric storage batteries located on the vehicle for driving and propelling the vehicle.

It is another object of the present invention to provide a vehicle with electric storage batteries thereon for collecting electricity produced by wind drive turbine blades mounted on the vehicle, wherein the storage batteries have an electric plug for connection to the grid of a house or building for supplying electric power to them.

### SUMMARY OF THE INVENTION

The present invention provides a wind-powered vehicle having turbine blades mounted on the vehicle at a location to receive wind to rotate the blades when the vehicle is being driven. A generator is connected to the turbine blades so that when the turbine blades rotate the generator produces electricity. One or more ducts are disposed behind the turbine blades to guide the wind to one or more exit ports on the ducts. One or more storage batteries are located on the vehicle for receiving and storing electricity produced by the generator. One or more electric wires are connected between the generator and the storage batteries for transferring the electricity produced by the generator to the storage batteries. The electric batteries are connected to the vehicle to drive and propel the vehicle.

### BRIEF DESCRIPTION OF THE DRAWINGS

FIG. 1 is a side view of a vehicle showing the turbine blades, generator, ducts, and batteries therein for propelling the vehicle;

FIG. 2 is a top view of a vehicle showing the turbine blades, generator, ducts, and batteries therein for propelling the vehicle; and

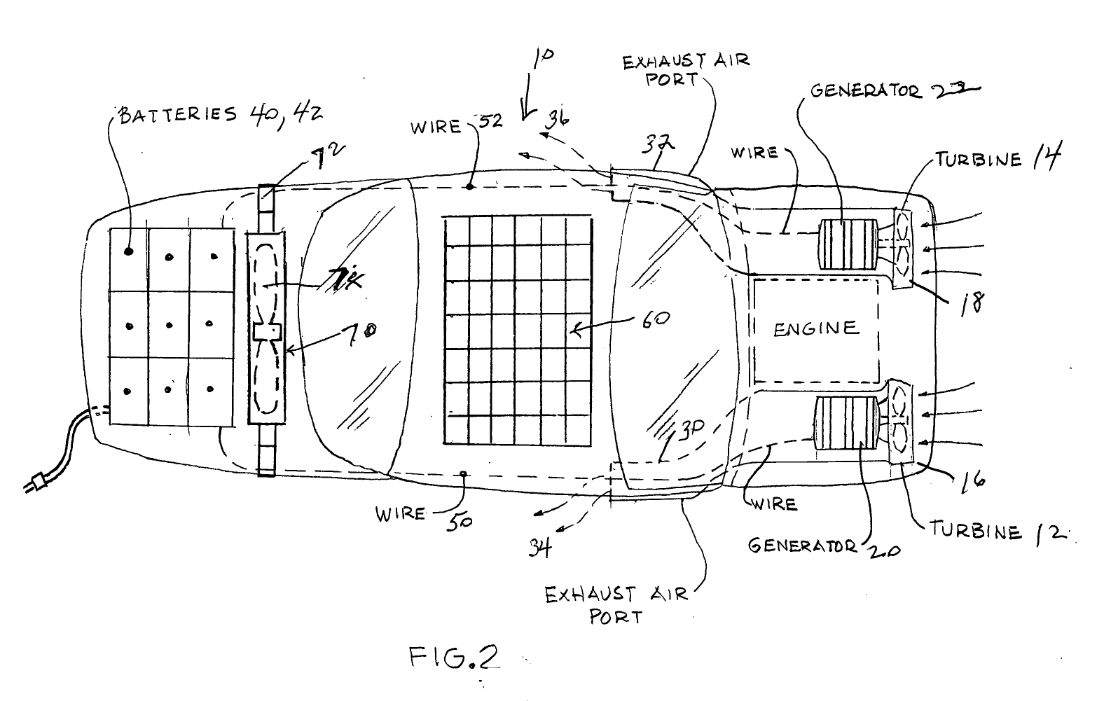

FIG. 3 is a side view of a trailer for attaching to a vehicle, and the trailer shows the turbine blades, generator, ducts, and batteries therein for propelling the vehicle.

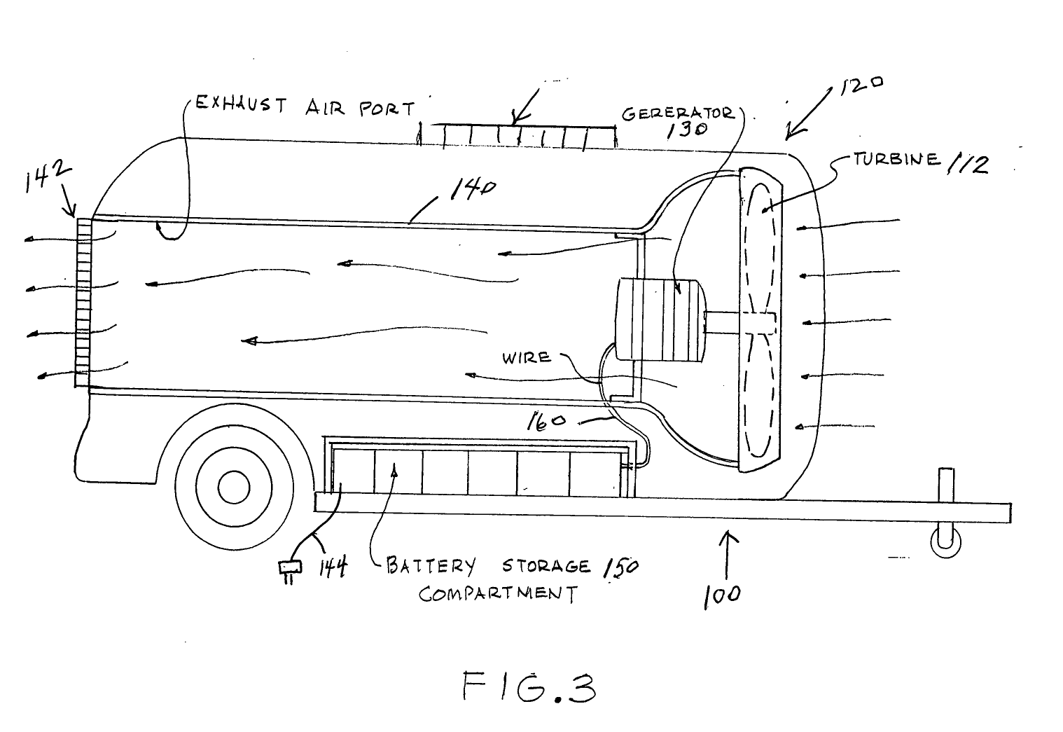

### DETAILED DESCRIPTION OF THE PREFERRED EMBODIMENT

The present invention provides a wind-powered vehicle 10 having two sets of turbine blades 12 and 14 mounted on the vehicle 10 at locations 16 and 18 to receive wind to rotate the blades 12 and 14 when the vehicle 10 is being driven. Generators 20 and 22 are connected to the turbine blades 12 and 14 so that when the turbine blades 12 and 14 rotate the generators 20 and 22 produces electricity. Two ducts 30 and 32 are disposed behind the turbine blades 12 and 14 to guide the wind to one or more exit ports 34 and 36 on the ducts 30 and 32. One or more storage batteries 40 and 42 are located on the vehicle 10 for receiving and storing electricity produced by the generators 20 and 22. One or more electric wires 50 and 52 are connected between the generators 20 and 22 and the storage batteries 40 and 42 for transferring the electricity produced by the generators 20 and 22 to the storage batteries 40 and 42. The electric batteries 40 and 42 are connected to the vehicle 10 to drive and propel the vehicle.

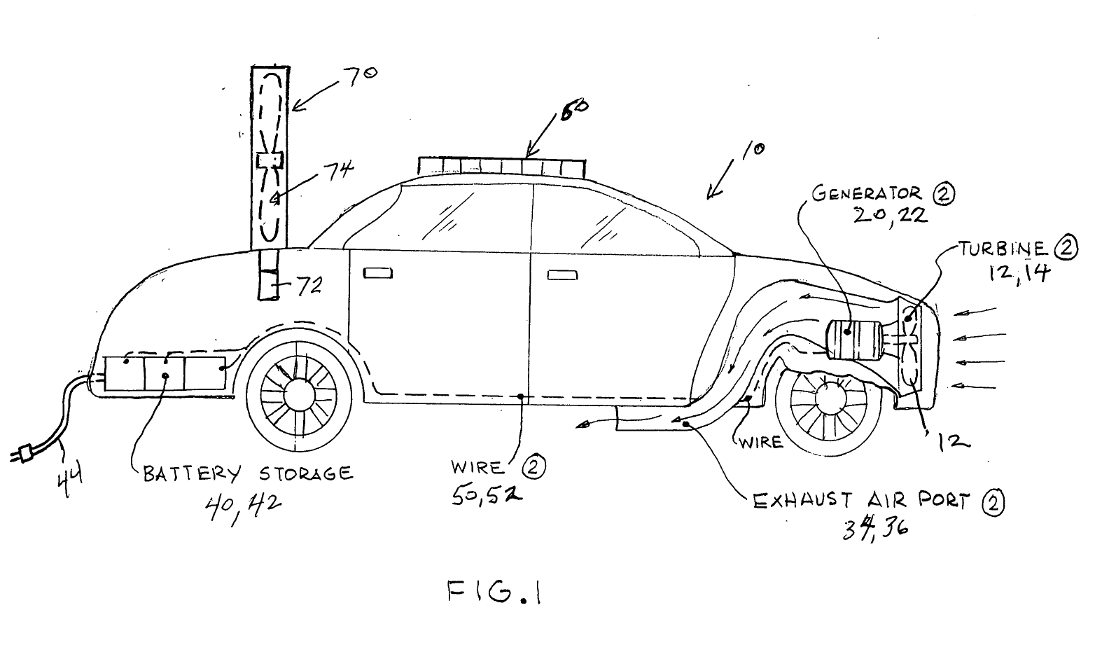

In addition, as shown in FIG. 1, the vehicle 10 has a solar membrane 60 mounted on the roof of the vehicle, which supplies electric energy to the storage batteries 40 and 42. In addition, in the preferred embodiment, storage batteries 40, 42 are connected to a wire and plug 44 to provide electric power to a grid in a building or home, in order to provide electric power to the building or home.

Further, as shown in FIG. 1, a turbine blade 70 is mounted on the trunk of the vehicle 10 by straps or other means 72. The turbine blades 74 of turbine 70 are also connected to a generator which transfers the electricity produced by turbine 70 to storage batteries 40, 42. Although 3 sets of turbine blades are shown on the vehicle, it should be understood that additional turbine blades may be added, if needed.

Alternatively, vehicle 10 may be powered by a conventional gas engine, or may be a hybrid vehicle. In such a case, the storage batteries 40, 42 of vehicle 10 would be used to operate in a V2G mode to supply power from the batteries to any type of electric grid, using plug 44 to plug into a grid.

In another embodiment, a trailer 100 is provided for mounting wind powered apparatus 120. Turbine blades 112 are mounted on the trailer 100 at a location to receive wind to rotate the blades when the trailer is being driven. A generator 130 is connected to said turbine blades 112 so that when the turbine blades rotate the generator 130 produces electricity. One or more ducts 140 is disposed behind said turbine blades to guide the wind to one or more exit ports 142 on the ducts 140. One or more storage batteries 150 are located on the trailer 100 for receiving and storing electricity produced by said generator 130. One or more electric wires 160 are connected to said generator and said storage batteries for transferring the electricity produced by said generator to said storage batteries 150. The electric batteries are electrically connected and mounted on said trailer 100. In addition, in the preferred embodiment, storage batteries 150 are connected to a wire and plug 144 to provide electric power to a grid (V2G) in a building or home, in order to provide electric power to the building or home.

### ADVANTAGES OF THE PRESENT INVENTION

An advantage of the present invention is that it provides a vehicle with wind driven turbine blades connected to a generator for producing electricity which is supplied to electric storage batteries located on the vehicle for driving and propelling the vehicle.

Another advantage of the present invention is that it provides a vehicle connected to a trailer, wherein the trailer has the wind drive turbine blades connected to a generator for producing electricity which is supplied to electric storage batteries located on the vehicle for driving and propelling the vehicle.

Another advantage of the present invention is that it provides a vehicle with electric storage batteries thereon for collecting electricity produced by wind drive turbine blades mounted on the vehicle, wherein the storage batteries have an electric plug for connection to the grid of a house or building for supplying electric power to them.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A wind-powered vehicle, comprising:
a) turbine blades mounted on said vehicle at a location to receive wind to rotate the blades when the vehicle is being driven;
b) a generator connected to said turbine blades so that when the turbine blades rotate the generator produces electricity;
c) one or more ducts disposed behind said turbine blades to guide the wind to one or more exit ports on the ducts;
d) one or more storage batteries located on the vehicle for receiving and storing electricity produced by said generator;
e) one or more electric wires connected to said generator and said storage batteries for transferring the electricity produced by said generator to said storage batteries; and
f) said electric batteries being connected to said vehicle to drive and propel said vehicle.

2) A wind powered vehicle in accordance with claim 1, further including a solar membrane 60 mounted on the vehicle for converting solar power into electricity for storage in batteries 40, 42.

3) A wind powered vehicle in accordance with claim 1, further including turbine blades 70 mounted on the vehicle connected to generators mounted in the vehicle for producing electricity, which is supplied to said storage batteries 40, 42.

4) A wind powered vehicle in accordance with claim 1, further including an electric wire and plug 44 connected to batteries 40, 42 for supplying electricity to an electric grid (V2G), such as a power grid, or a grid in a building.

5) A trailer for connection to a wind powered vehicle, comprising:
a) turbine blades mounted on said trailer at a location to receive wind to rotate the blades when the vehicle is being driven;
b) a generator connected to said turbine blades so that when the turbine blades rotate the generator produces electricity;
c) one or more ducts disposed behind said turbine blades to guide the wind to one or more exit ports on the ducts;
d) one or more storage batteries located on the trailer for receiving and storing electricity produced by said generator;
e) one or more electric wires connected to said generator and said storage batteries for transferring the electricity produced by said generator to said storage batteries; and
f) said electric batteries being electrically connected to said vehicle to drive and propel said vehicle.

6) A vehicle driven by an internal combustion engine having electric storage batteries thereon for collecting electricity produced by wind driven turbine blades mounted on the vehicle, comprising:
a) turbine blades mounted on said vehicle at a location to receive wind to rotate the blades when the vehicle is being driven;
b) a generator connected to said turbine blades so that when the turbine blades rotate the generator produces electricity;
c) one or more ducts disposed behind said turbine blades to guide the wind to one or more exit ports on the ducts;
d) one or more storage batteries located on the vehicle for receiving and storing electricity produced by said generator;
e) one or more electric wires connected to said generator and said storage batteries for transferring the electricity produced by said generator to said storage batteries; and
f) said electric storage batteries having an electric plug for connection to the grid of a house or building for supplying electric power to the house or building.
